(19) United States
(12) Patent Application Publication
(10) Pub. No.: US 2018/0349914 A1
(43) Pub. Date: Dec. 6, 2018

(54) Continuous Product Service Mechanism

(71) Applicant: Mark Newsome, Minneapolis, MN (US)

(72) Inventor: Mark Newsome, Minneapolis, MN (US)

(21) Appl. No.: 15/609,021

(22) Filed: May 31, 2017

(51) Int. Cl. G06Q 30/00; G06Q 40/02

(52) U.S. Cl. CPC G06Q 30/012; G06Q 40/025

(57) ABSTRACT

A method of improving a product, and the utility of the product, through the integration of a risk protection mechanism, a service mechanism, an upgrade mechanism, a periodic payment mechanism, a customer agreement mechanism, an opt-out mechanism, and a maintenance protection mechanism.

### BACKGROUND OF THE INVENTION

Most buyers of products do not desire a product itself when evaluating the purchase of the product. Rather, buyers typically desire the utility provided by the product. For example, a buyer of a medical device, such as a hearing instrument, does not seek solely to own the medical device for the sake of owning it. Rather, the buyer of a medical device seeks the utility provided by the medical device. Given that buyers generally seek the utility of products, buyers generally also seek such utility over a period of time. In contrast to the desire by buyers to consume the utility of products, product manufacturers, and retailers of products, generally seek to sell products without consideration of the utility sought by buyers over a period of time. Rather, manufacturers, and retailers, generally seek to be paid for the sale of products at the point of sale. In addition, manufacturer warranties, or other warranties, typically do not satisfy all of the requirements necessary to support, or ensure, the continued utility of said products over the expected consumption time of said products. If, for example, consideration for the utility of a product is made, manufacturers of said product, and retailers of said product, generally address such consideration of utility consumption over time by proposing the sale of an additional product, such as an extended warranty, which may or may not be offered by said manufacturers, or said retailers, at the point of sale, or at all. While an extended warranty may provide some value, said extended warranty generally does not satisfy all of the needs of buyers seeking the consumption of utility of a product over time. In addition, the additional decisions resulting from, for example, the offer to purchase an extended warranty, or other additional services offered in conjunction with the purchase of a product, increase the number of decisions made by a buyer, which reduces the probability that the buyer would buy said product, since the number of decisions related to the purchase of said product has been increased.

For example, a buyer decides to buy a product that meets a desired utility over time; during the sale process, the buyer asks about the expected life of said product, which prompts the sales person to offer an extended warranty for said product; the buyer would then typically think about many factors including the expected life of said product with, or without, said extended warranty, the features of said extended warranty, the terms of said extended warranty, the price of said extended warranty, and the value proposition of said extended warranty; the buyer would then have to decide to proceed with the purchase of said product with, or without, said extended warranty, or leave the retailer to think about said product, the expected utility of said product, and whether or not to purchase said extended warranty; in addition, for example, the customer may be presented with additional choices such as services for said product, or financing for said product. Each decision added to the purchase process increases the complexity of the purchase of said product, making the decisions whether or not to purchase said product, the expected utility of said product over a period of time, and the additional purchases related to said product, more difficult, reducing the probability that a purchase of said product would occur without additional consideration, and decision-making. The present application is designed generally to reduce, or alleviate, the multiple decisions generally presented to a buyer at the point of sale for a product, integrate said product with risk protection, service, upgrade, periodic payments aligned with the expected utility consumption of said product, to support, and ensure, the utility consumption of said product, maintenance protection if the utility of said product is consumed beyond, for example, the expected utility consumption timeframe, or agreement term, and the ability to opt out of, or make changes to, said agreement.

### SUMMARY OF THE INVENTION

The present application focuses on integrating a product with risk protection, service, upgrade, periodic payments, customer agreement, opt-out, and maintenance protection, and aligning, for example, said product, and integration provisions, with, for example, the expected utility consumption timeframe, or the expected useful life. Given that buyers generally do not purchase products independent of the expected utility of said products, the expected utility of said products is integral to the decision to purchase said products. One aspect of the present application provides a buyer with a product that includes risk protection to ensure satisfactory utility of said product over time. A second aspect of the present application provides said buyer with services to ensure continuing utility of said product over time. A third aspect of the present application allows said buyer to upgrade said product to a new product, or a different product. A fourth aspect of the present application facilitates periodic payment for the product, and its utility, over, for example, the expected utility consumption timeframe of said product, or the expected useful life of said product. A fifth aspect of the present application provides for the creation of an agreement related to said product, and said aspects, described in the present application. A sixth aspect of the present application provides for the ability to opt out of any, or all of, or make changes to, said aspects, said agreement, or said mechanisms. A seventh aspect of the present application provides for the maintenance protection of said product if, for example, said buyer consumes the utility of said product beyond the expected utility consumption timeframe, or said agreement maturity date.

### BRIEF DESCRIPTION OF THE DRAWINGS

FIG. 1 depicts the typical buying experience for a buyer purchasing a product, such as hearing instruments. As is depicted in FIG. 1, said buyer is generally presented with many potential counterparties, and potential decisions related to the purchase of said product, and said counterparties may not interact with said buyer in a particular order, or sequence. For example, Seller of Product 20 may, or may not, offer service for said product, repair or replacement of said product, financing of said product, or protection of said product. Each decision added to the decision by said buyer to purchase said product generally increases the complexity of said purchase decision, and reduces the probability of said buyer making said product purchase decision at the time of presentation of said product purchase decision, or related decisions, or making said purchase decision made by Seller 20 without, for example, shopping at additional sellers, conducting further research, or not making said purchase decisions at all given, for example, the complexity of the purchase decisions.

FIG. 2 is a diagram illustrating an exemplary process for the present application where, for example, a buyer purchases a product that provides utility that, for example, is expected to be consumed over time, and said product is integrated with risk protection, service, the option to upgrade said product, or receive a different product, periodic payments, agreement, the ability to opt-out, or make changes, and maintenance protection. The embodiments in FIG. 2 are presented for illustration purposes and the ordering, or sequence, of said mechanisms in FIG. 2 is not germane to the present application. The facilitation of each mechanism in FIG. 2 may be made in any order, or sequence.

FIG. 3 is a diagram illustrating an exemplary process where, for example, the Maintenance Protection Mechanism 1000 is activated for said product in FIG. 2 when the utility of said product is consumed beyond, for example, the agreement term, or expected useful life, or another product such as, for example, a replacement product, where said product is integrated with risk protection, service, the ability to upgrade said product, or receive a different product, periodic payments, agreement, the ability to opt-out, or make changes, and maintenance protection. The embodiments in FIG. 3 are presented for illustration purposes and the ordering, or sequence, of said mechanisms in FIG. 3 is not germane to the present application. The facilitation of each mechanism in FIG. 3 may be made in any order, or sequence.

### DETAILED DESCRIPTION OF THE INVENTION

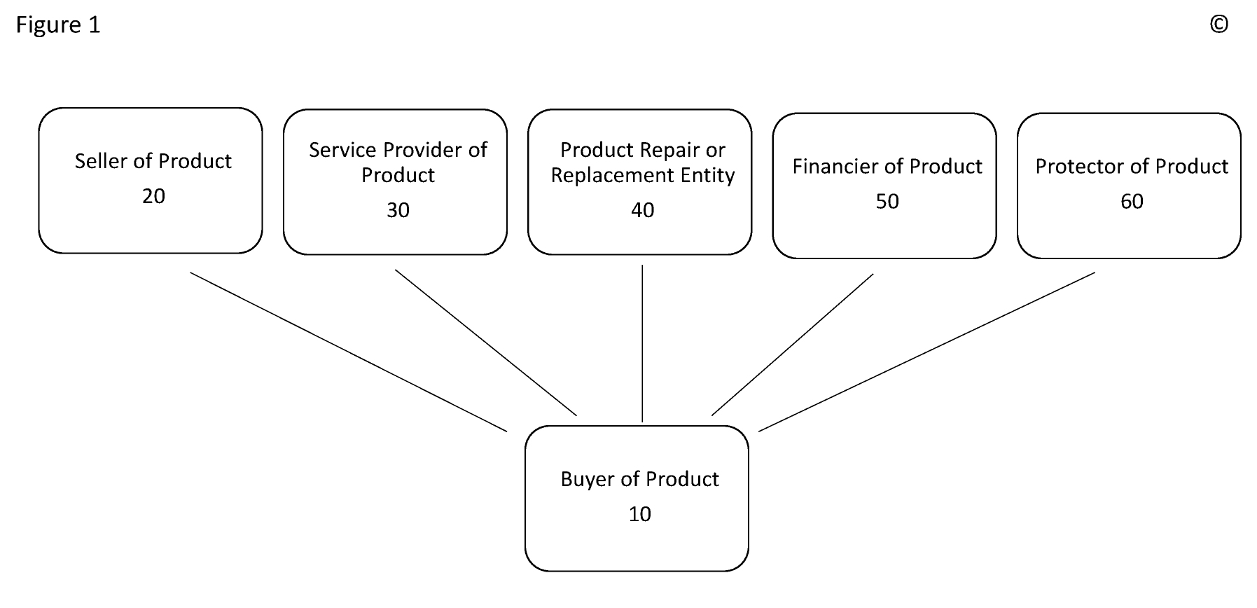

The typical existing systems and methods, and prior systems and methods, for the sale and use of products, such as hearing instruments, exemplified in FIG. 1 for Buyer of Product 10 generally consists of many elements such as (but not limited to) Seller of Product 20 (which may, or may not, be the manufacturer of the product), Service Provider of Product 30 (which may, or may not, be Seller 20), Product Repair or Replacement Entity 40 (which may interact with Buyer 10, Seller 20, or Service Provider 30), Financier of Product 50, which may offer financing directly to Buyer 10, or indirectly to Buyer 10 through Seller 20, and Protector of Product 60 which may, or may not, sell protection at the point of sale of said product, or may sell protection after the manufacturer warranty for said product has expired, may not offer protection desired by Buyer 10, may, or may not, interact directly with Buyer 10, Seller 20, Service Provider 30, or Product Repair or Replacement Entity 40.

Under any scenario, Buyer 10, under the typical existing systems and methods, and prior systems and methods, exemplified in FIG. 1 faces many decisions, and counterparties, for the utility consumption of said product. In addition, Buyer 10 faces uncertainty about future costs to maintain the utility consumption of said product over time given that, for example, Buyer 10 may not be made aware of risk protection, service plans, or repair costs, until after the purchase of said product. Furthermore, Buyer 10 may be unaware of available support, service, or risk protection for said product if, for example, Seller 20 does not inform Buyer 10 of said support, service, or risk protection. In addition, Seller 20 may, for example, prefer to have Buyer 10 purchase new products, rather than receive benefits from support, service, or risk protection that may be available for said product. For example, some manufacturers of hearing instruments may replace a lost hearing instrument one time; after said one-time replacement, said replaced product generally no longer has a manufacturer warranty; Buyer 10 may not know, for example, that Protector 60 would be willing to sell protection for said replaced product unless Seller 20 informs Buyer 10 of said protection from Protector 60. Under the present application, Buyer 10 would receive benefits, for example, from Risk Protection Mechanism 200, and Service Mechanism 300, that would continue to protect, and support, the utility consumption of said replacement product beyond the one-time replacement.

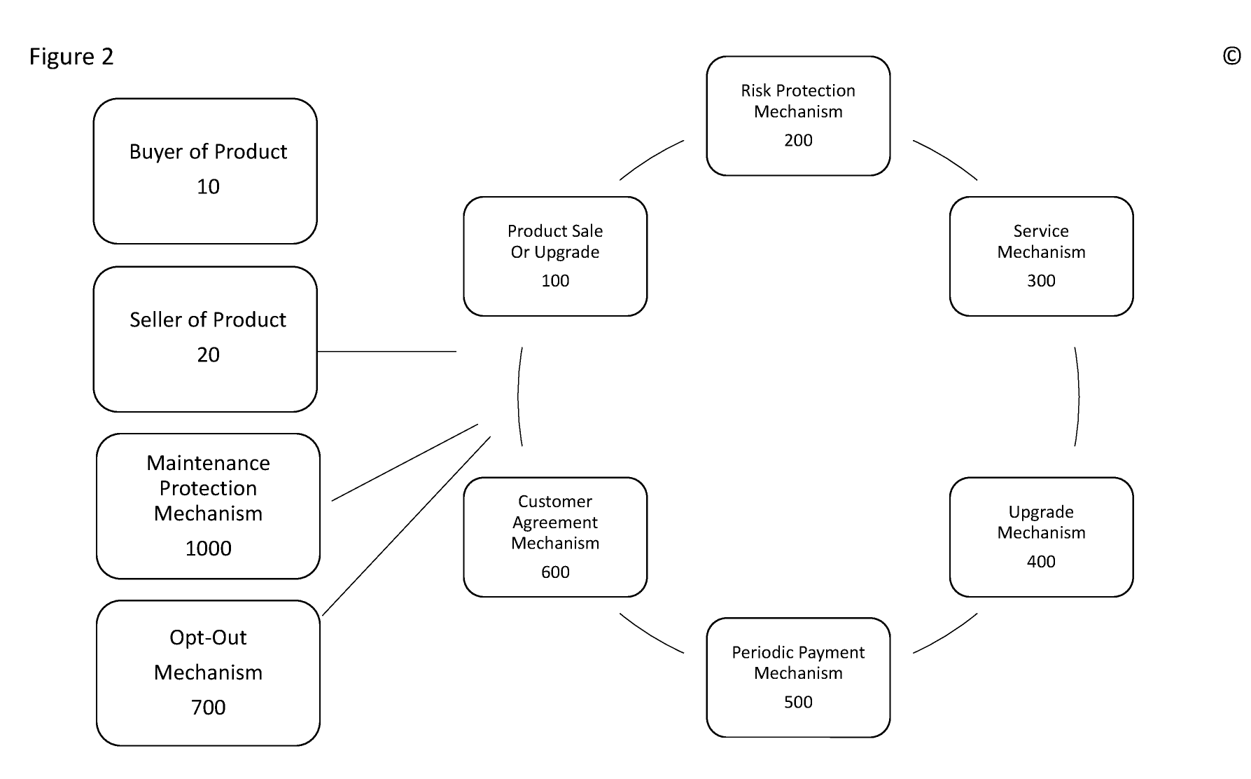

The present application contains advantages, and improvements, for the facilitation of the purchase experience, and ownership experience of said product. For example, embodiments contained in FIG. 2 illustrate the mechanisms that would improve, and simplify, the purchase experience, and utility consumption experience, for Buyer 10. Under the present application in FIG. 2, Buyer 10 enters into an agreement where Buyer 10 receives a product, and said product is integrated with said mechanisms to support, and ensure, continued utility consumption of said product over a period of time, such as the expected useful life of said product.

Under the present application in FIG. 2, Product Sale or Upgrade 100 represents, for example, the facilitation of a transaction that includes, for example, the delivery of a product, or upgrade, to Buyer 10 by Seller 20, integration of Risk Mechanism 200, Service Mechanism 300, Upgrade Mechanism 400, Periodic Payment Mechanism 500, Customer Agreement Mechanism 600, Opt-Out Mechanism 700, and Maintenance Protection Mechanism 1000. After the sale of said product and integration of said mechanisms, Buyer 10 would consume the utility of said product, and said mechanisms would support, and ensure, the continued utility consumption of said product.

Risk Protection Mechanism 200 facilitates the provision of risk protection of said product against risks such as (but not limited to) mechanical breakdown, accidental damage, loss, or mortality. Said Risk Protection Mechanism 200 would be facilitated through, for example, methods such as product information, Buyer 10 information, and other information, stored, operated, and managed, in a database, and communication by way of, for example, telephone, electronic communication, in person, by presenting said product, for example, in person, by way of mail, or delivery service.

Service Mechanism 300 facilitates the provision of services for said product to support, and maintain, the utility of said product. Said Service Mechanism 300 would be facilitated through, for example, methods such as product information, Buyer 10 information, and other information, stored, operated, and managed, in a database, and communication by way of, for example, telephone, electronic communication, in person, by presenting the product in person, by delivering the product by way of, for example, mail, or a delivery service, receiving service items in person, or receiving service items by way of, for example, mail, or delivery service.

Upgrade Mechanism 400 facilitates the provision of a new product, or a different product, to Buyer 10 when, for example, said product reaches the end of its useful life, the agreement maturity date, when said product becomes obsolete, or when new products are available that are desired by Buyer 10. Said Upgrade Mechanism 400 would be facilitated through, for example, methods such as product information, Buyer 10 information, and other information, stored, operated, and managed, in a database, and communication by way of, for example, telephone, electronic communication, in person, by presenting the product, and the delivery of an upgrader product, for example, in person, by way of mail, or a delivery service.

Periodic Payment Mechanism 500 facilitates the payment notices to Buyer 10, and collection of payments made by Buyer 10. Said Periodic Payment Mechanism 500 would be facilitated through, for example, methods such as product information, Buyer 10 information, and other information, stored, operated, and managed, in a database, and communication by way of, for example, writing on paper, mail, delivery service, electronic communication, or in person. Said payments under Periodic Payment Mechanism 500 may be made by Buyer 10 in periods such as, for example, monthly, quarterly, annually, or in full. Said payments may be made by Buyer 10 through methods such as, for example, credit card, debit card, or electronic funds transfer.

Customer Agreement Mechanism 600 facilitates the collection of information, and said mechanisms under the present application. Said Customer Agreement Mechanism 600 would be facilitated through, for example, methods such as product information, Buyer 10 information, and other information, stored, operated, and managed, in a database, and communication by way of, for example, writing on paper, mail, delivery service, electronic communication, or in person. The collection, and delivery, of said information under said Customer Agreement Mechanism 600 may be made by way of, for example, electronic communication, mail, delivery service, or in writing on paper.

Opt-Out Mechanism 700 provides for the ability to terminate, or change, any, or all, of the provisions of the agreement. Said Opt-Out Mechanism 700 would be facilitated through, for example, methods such as product information, Buyer 10 information, and other information, stored, operated, and managed, in a database, and communication by way of, for example, writing on paper, mail, delivery service, electronic communication, or in person. The communication of an opt-out notice may be made by way of, for example, electronic communication, mail, delivery service, or in writing on paper.

Maintenance Protection Mechanism 1000 facilitates the mechanisms under the present application when, for example, Buyer 10 does not utilize said upgrade provision under Upgrade Mechanism 400, and elects to continue to utilize the mechanisms under the present application for said product that was not upgraded, or, for example, when Buyer 10 elects to have another product that was not sold by Seller 20, integrated with the mechanisms under the present application. Said Maintenance Protection Mechanism 1000 would be facilitated through, for example, methods such as product information, Buyer 10 information, and other information, stored, operated, and managed, in a database, and communication by way of, for example writing on paper, mail, delivery service, electronic communication, or in person.

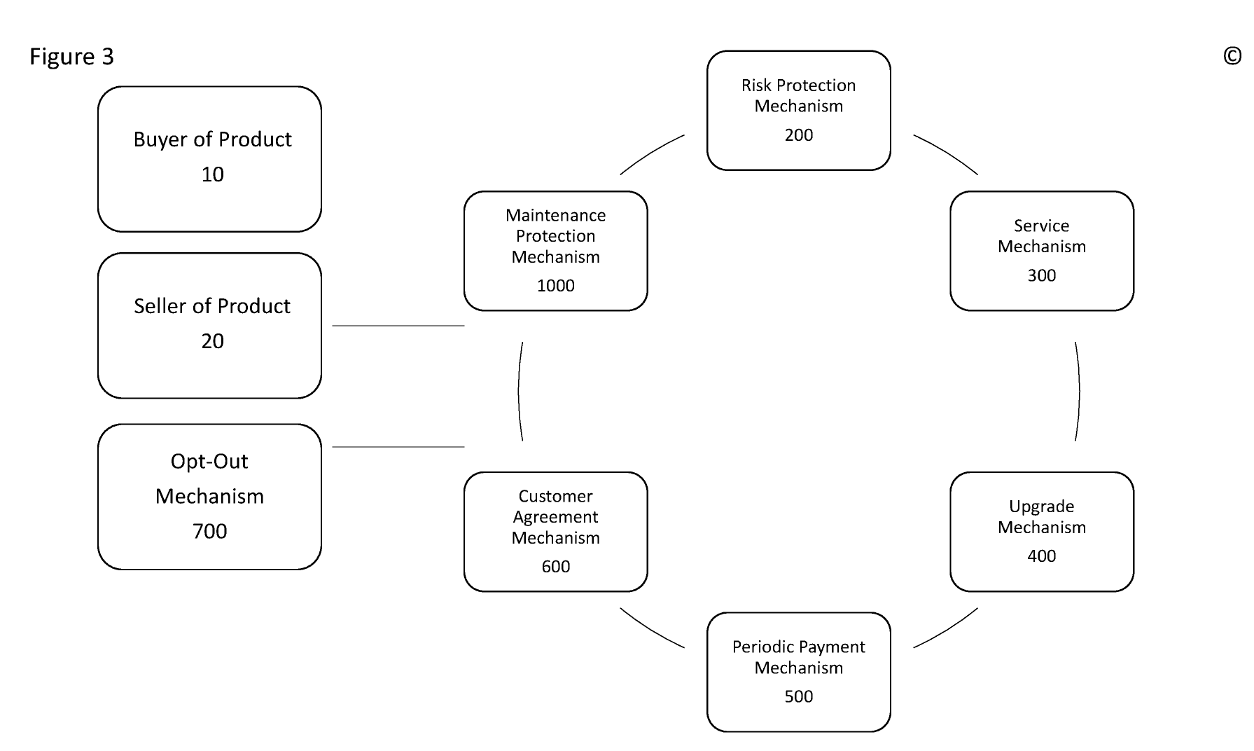

Under the present application in FIG. 3, Maintenance Protection Mechanism 1000 is facilitated through Risk Protection Mechanism 200, Service Mechanism 300, Upgrade Mechanism 400, Periodic Payment Mechanism 500, Customer Agreement Mechanism 600, and Opt-Out Mechanism 700.

The present application provides many advantages to the utility of a product, and the consumption of said utility. In addition, buyers that purchase a product under the present application would have an improved purchase experience resulting from, for example, one decision for a product that includes the benefits from the mechanisms described herein, improved utilization experience, and improved awareness of methods to ensure, and protect, the utility of said product. Furthermore, a manufacturer, or retailer, offering products under the present application would benefit from improved customer experiences, and through the simplification of the ancillary, or additional, offerings with said products, such as extended warranties, or service plans, since said products offered under the present application would satisfy, for example, all of the needs that customers would have related to said products. While there are many specific elements contained in the present application, these specifics should not be interpreted, or construed, as limitations on the scope of the present application. Many other variations may occur and the specifics provided in the present application should be construed as exemplification of the embodiments contained herein. Accordingly, the scope of the present application should not be limited by the embodiments contained herein. Rather, the scope of the present application should be determined by the appended claims and their legal equivalents. Therefore, the reader will see, and appreciate, that the utility of a product is enhanced, and improved, through the advantages contained in the present application.

What is claimed:

1. A method of selling a product where a product is combined with a risk protection mechanism, a service mechanism, an upgrade mechanism, a periodic payment mechanism, a customer agreement mechanism, an opt-out mechanism, and a maintenance protection mechanism.

2. The method of claim 1, wherein the Risk Protection Mechanism 200 facilitates the protection against risks such as (but not limited to) mechanical breakdown, accidental damage, loss, or mortality.

3. The method of claim 1, wherein the Service Mechanism 300 facilitates the provision of services such as (but not limited to) product tuning, adjustments, repair, technical support or accessory items to, for example, support or enhance the continuing functioning, and utility of the product.

4. The method of claim 1, wherein the Upgrade Mechanism 400 facilitates the provision of the option to replace a product with a new, upgraded, or different product when, for example, said product reaches the end of its useful life, the occurrence of an agreement maturity date, becomes obsolete or when, for example, new, improved, or different products are recommended, or become available.

5. The method of claim 1, wherein the Periodic Payment Mechanism 500 facilitates the provision of the option to pay on a periodic basis such as monthly through, for example, credit card, debit card, check, cash, an agreement, installment contract, loan, lease or other means.

6. The method of claim 1, wherein the Customer Agreement Mechanism 600 facilitates the provision for the collection, and management of information, such as (but not limited to) customer information, and product information, and for the customer to agree to the terms, and conditions.

7. The method of claim 1, wherein the Opt-Out Mechanism 700 facilitates the provision of the option to, for example, terminate, or change, any or all of the mechanisms under claim 1;
wherein the process would continue if an opt-out, or changes do not occur.

8. The method of claim 1, wherein the Maintenance Protection Mechanism 1000 facilitates the provision for the continued provision of the Risk Protection Mechanism 200, Service Mechanism 300, Upgrade Mechanism 400, Periodic Payment Mechanism 500, and Customer Agreement Mechanism 600 for a product when, for example, said product is utilized beyond the agreement maturity date, for a replacement product, or for a product purchased outside of the mechanisms under claim 1 where a buyer chooses to include said outside product in the mechanisms under claim 1.
